(19) United States
(12) Patent Application Publication
(10) Pub. No.: US 2005/0051009 A1
(43) Pub. Date: Mar. 10, 2005

(54) Apparatus for forming a baffle

(76) Inventor: Ronald Malcolm Bond Sanderson, Lower Hutt (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/494,982

(22) PCT Filed: Nov. 8, 2002
(86) PCT No.: PCT/NZ02/00240

(30) Foreign Application Priority Data
Nov. 8, 2001 (NZ) 515347

(51) Int. Cl. B26D 7/06

(52) U.S. Cl. 83/401; 83/669

(57) ABSTRACT

A perforation apparatus includes a punch housing 4 having an aperture through which 8 piping is longitudinally and rotationally moveable and one or more punches 7 arranged radially around the aperture to perforate the piping, a driven annular housing 3 including an aperture corresponding to the punch housing aperture, a punch retracting mechanism 5, and one or more rollers 6 axially secured to the annular housing, with the annular housing 3 rotatable adjacent the punch housing 4 such that the or each roller 6 rolls around the punch housing 4 and operates the or each punch 7 upon contact, and wherein the retracting 5 mechanism retracts the or each punch after said contact. A control system may be provided to coordinate the longitudinal and rotational movement of the piping with the operation of the punches. A mandrel assembly may also be provided to support the piping during punching and to remove punch waste.

### FIELD OF INVENTION

The invention comprises an apparatus for perforating piping, tubing or the like.

### BACKGROUND

A variety of apparatus for perforating by cold stamping materials such as metal or plastics piping are known. Typically these utilise a reciprocating punch wherein after one perforation has been formed the punch retracts allowing the work material to be re-orientated or further fed through the apparatus. The punch is typically retracted using spring release mechanisms which are prone to jamming and limit the speed of operation of the punch. A further disadvantage of currently available apparatus is that they are restricted to a single pattern of perforations.

### SUMMARY OF INVENTION

It is an object of the present invention to provide an improved or at least alternative perforation apparatus.

In accordance with a first aspect of the present invention, there is provided a perforation apparatus suitable for perforating tubing or piping including:
a punch housing including an aperture through which piping is longitudinally and rotationally moveable and one or more punches arranged radially around the aperture and operable to perforate piping passing through the punch housing;
a driven annular housing including an aperture corresponding to the punch housing aperture, one or more rollers axially secured to the annular housing, the annular housing being arranged to rotate adjacent the punch housing such that roller(s) roll(s) around the punch housing to operate the punch(es) upon contact, and a punch retracting mechanism arranged to retract the punch(es) after each operation;
a mechanism to move the piping relative to the punch housing; and
a mechanism to drive the annular housing and the piping moving mechanism.

In accordance with a second aspect of the present invention, there is provided a perforation apparatus suitable for perforating tubing or piping including:
a punch housing including an aperture through which piping is longitudinally and rotationally moveable and one or more punches arranged radially around the aperture and operable to perforate piping passing through the punch housing;
a driven annular housing including an aperture corresponding to the punch housing aperture and a punch retracting mechanism, the annular housing being arranged to rotate adjacent the punch housing;
either the punch(es) or the annular housing including one or more camming surfaces and the other of the punch(es) and the annular housing including one or more engagement surfaces, the annular housing being arranged to rotate adjacent the punch housing such that the camming surface(s) engage(s) the engagement surface(s) to operate the punch(es) upon contact, the punch retracting mechanism arranged to retract the punch(es) after each operation;
a mechanism to move the piping relative to the punch housing; and
a mechanism to drive the annular housing and the piping moving mechanism

Preferably, the punch(es) include(s) a roller, and the annular housing includes one or more cam shafts. Alternatively, one or more rollers may be axially secured to the annular housing and arranged to engage a surface on the punch(es) during rotation of the annular housing.

Advantageously, the punch retracting mechanism includes a channel or recess around the annular housing which co-operates with a projection from the punch(es) wherein the profile of the channel or recess is such that the punch(es) is/are retracted after each operation. Alternatively, the punch retracting mechanism may include a punch retracting disk with an external profile which co-operates with a projection from the punch(es) wherein the external profile of the punch retracting disk is such that the punch(es) is/are retracted after each operation, and the punch retracting mechanism is formed integrally with or secured to the driven annular housing.

In a preferred embodiment, roller(s) is/are axially secured to the annular housing, and the channel or recess around the annular housing or the external profile of the punch retracting disk is substantially circular in shape, but includes one or more regions of reduced radius or one or more dips radially aligned with the roller(s).

The projection preferably includes at least one wheel or small roller which engages the punch retracting mechanism

The punch housing suitably includes one or more radial apertures for receipt of the punch(es).

In a preferred embodiment, the punch housing includes an inner punch housing part having an aperture through which piping is longitudinally and rotatably moveable and an outer punch housing part, the inner and outer punch housing parts being separable. The inner punch housing part may be interchangeable with a further inner punch housing part having a different internal diameter for receipt of different diameter piping.

The inner punch housing part preferably includes a hub and a flange, which are receivable in respective parts of a central stepped aperture of the outer punch housing part.

Preferably, in the embodiment including one or more radial apertures, the radial aperture(s) extend(s) through the inner and outer punch housing parts when the housing parts are engaged together.

The inner housing part and/or outer housing part may include one or more apertures for receipt of one or more fasteners to fasten the housing parts together.

In a preferred embodiment, the inner housing part also serves as a tool holder and is separable from the outer housing part with the punches maintained in the inner housing part.

Preferably, the or each punch includes a projection which co-operates with the punch retracting mechanism, the outer punch housing part including a corresponding number of elongate radial slots through which a respective projection extends.

The aperture of the punch housing or the inner punch housing part through which piping is longitudinally and rotatably moveable advantageously includes a plurality of arcuate grooves to reduce friction on piping therein. Alternatively or in addition, the aperture of the punch housing or the inner punch housing part through which piping is longitudinally and rotatably moveable may be flared to guide movement of piping therethrough.

The periphery of the driven annular housing suitably includes a plurality of teeth, such that rotation of the annular housing may be effected using a chain, toothed belt, or gears.

In a preferred embodiment, the punch(es) is/are receivable in a respective punch holder(s), which is/are receivable in the punch housing. The punch holder(s) suitably include(s) a main body portion including a substantially T-shaped slot at one end thereof for receipt of a punch or insert.

The punch holder(s) preferably include(s) a removable insert having a tubular body and an enlarged head, the head being receivable within the substantially T-shaped slot of the punch holder(s), with the punch receivable in the insert. In the embodiment having inner and outer punch housing parts, the apparatus is preferably arranged such that as the inner punch housing part is detached from the outer punch housing part, the punch holder insert(s) is/are detached from the substantially T-shaped slot(s) of the punch holder main body portion(s) and held within the inner housing part.

The punch holder(s) preferably include(s) a main body portion, the main body portion including a transverse aperture for receipt of a pin to form the projection to engage with the punch retracting mechanism.

The punch holder(s) preferably include(s) a main body portion, with an end of the main body portion including an offset protrusion against which the roller(s) engage(s) in use. The mechanism to drive the annular housing suitably includes a motor, which is most preferably an electric servo motor.

The mechanism to move the piping relative to the punch housing preferably includes a chuck arranged to selectively grip the piping. The mechanism to drive the piping moving mechanism is preferably configured to longitudinally and rotationally move the chuck. The mechanism to drive the piping moving mechanism may include independently actuable rotational and longitudinal drive motors, which are preferably electric servo motors.

The apparatus may include a mandrel assembly to support the piping during punching, which preferably includes an arbor and a die extending therefrom and configured to support the piping during punching. The die advantageously includes one or more radial apertures corresponding to the position of the punch(es).

In the embodiment including a plurality of apertures, the perimeter of the die advantageously includes semi-flat surfaces between the apertures to mininmise friction on the inside of the piping.

Suitably, the arbor is held within a clamping block, and is selectively releasable therefrom so that the die is axially and rotatably moveable relative to the punch(es).

The die preferably includes a second set of apertures axially spaced from the first set of apertures.

The interior of the arbor is preferably separated by a dividing wall into a fluid inlet path and a fluid outlet path, with the fluid inlet path in fluid communication with a source of high pressure fluid to remove waste punching material from inside the die.

The fluid is preferably a coolant fluid.

A die clamping collar is preferably provided to attach the die to the arbor. Preferably, a keyway is present in the outer surface of the arbor and the inner surface of the die, and a key is located in the keyways to maintain alignment between the die and the arbor, the key being maintained in the keyways by the die clamping collar.

In a particularly preferred embodiment, the perforation apparatus includes a control system configured to control and coordinate the longitudinal and rotational movement of the piping through the punch housing with the operation of the punch(es), to cause the apparatus to perforate a predetermined, selected part or parts of the piping, with a predetermined, selected arrangement or pattern of perforations.

The punch housing suitably includes eight punches at about 45 angular spacing for example. The annular housing preferably includes four rollers at about 90 angular spacing, or may include eight rollers at about 45 angular spacing for example.

In accordance with a third aspect of the present invention, there is provided a perforation apparatus suitable for perforating tubing or piping including:
a punch housing including an aperture through which the piping is longitudinally and rotationally movable and one or more punches arranged radially around the aperture and operable to perforate piping passing through the punch housing,
a mechanism to rotate and move the piping through the punch housing, and
a control system configured to control and coordinate the longitudinal and rotational movement of the piping through the punch housing with the operation of the punch(es), to cause the apparatus to perforate a predetermined, selected part or parts of the piping, with a predetermined, selected arrangement or pattern of perforations.

The punch housing preferably includes a plurality of punches arranged radially around the aperture.

Preferably, the control system enables an operator to select from a preset perforation pattern, customise a unique pattern or instruct the system to calculate a pattern automatically. The control system advantageously enables a user to input a piping length, piping diameter, hole diameter, wall thickness dimensions, and the number and size of the perforation zone(s).

Suitably, the control system is operable to calculate a pattern automatically based on the actual surface area, percentage of piping surface area, or percentage of cross-sectional area of the piping.

The control system preferably includes a computer, a display and an input device to enable a user to input or select a desired arrangement or pattern of perforations. The computer is suitably loaded with a computer program which allows an operator to select a preset perforation pattern, customise a pattern, or instruct the program to calculate a perforation pattern according to parameters.

Alternatively, the control system may enable an operator to select from a preset perforation pattern, and includes a programmable logic controller (PLC).

In accordance with a fourth aspect of the present invention, there is provided a mandrel assembly for supporting tubing or piping as it is being punched in a perforation apparatus including:
an arbor having an internal aperture divided by a dividing wall into a fluid inlet path and a fluid outlet path;
a die for supporting the tubing or piping and attached at or toward an end of the arbor, the die having a one or more radial apertures for receipt of one or more punches;
the fluid inlet path being directly or indirectly connectable to a source of high pressure fluid, and the fluid inlet path and fluid outlet path defining a flow path around which the high pressure fluid can flow to remove waste punch slugs from the vicinity of the die.

The fluid inlet channel is preferably in fluid communication with a source of high pressure coolant fluid.

The mandrel assembly preferably includes a die clamping collar to attach the die to the arbor. The mandrel assembly may include a keyway in an outer surface of the arbor and a corresponding keyway in an inner surface of the die, and a key located in the keyways to maintain alignment between the die and the arbor, the key being maintained in the keyways by the die clamping collar.

The control system is advantageously configured to control a punch actuation motor, a longitudinal piping movement motor and a rotational piping movement motor.

### BRIEF DESCRIPTION OF DRAWINGS

Preferred embodiments of the perforation apparatus of the present invention are described in detail with reference to the accompanying drawings, by way of example only and without intending to be limiting, in which:

FIG. 1 is an external view of a preferred embodiment perforating apparatus and control panel;

FIG. 2 is a partial section view of the apparatus along line AA;

FIG. 3 is a plan view of the perforating mechanism on line BB of the apparatus;

FIG. 4 is a close -up view of a punch of the perforating mechanism;

FIG. 5 is a view of a pipe perforated by the apparatus;

FIG. 6 shows a piping perforation pattern start-up screen;

FIG. 7 shows a completed piping perforation pattern screen;

FIG. 8 shows a New Pipe Dimensions Popup Screen; and

FIG. 9 shows a piping perforation pattern screen with a perforation location image.

FIG. 10 shows an edit zone popup screen;

FIG. 11 shows an add new set popup screen;

FIG. 12 shows an automatic pattern popup screen; and

FIG. 13 shows an automatically generated piping perforation pattern screen;

FIG. 14 shows a plan view of an inner body part of an alternative punch housing;

FIG. 15 shows a section view of the inner body part along line CC;

FIG. 15a shows a section view of an alternative inner punch housing part;

FIG. 16 shows a plan view of an outer body part which, with the inner body part of FIG. 14 comprises the alternative punch housing,

FIG. 17 shows a section view of the outer body part along line DD;

FIG. 18 shows an alternative annular housing for use with the punch housing of FIGS. 14 to 17;

FIG. 19 shows a section view of the annular housing along line EE;

FIG. 20 shows a section view of a punch holder/punch combination for use with the alternative embodiment punch housing and annular housing shown in FIGS. 14 to 19;

FIG. 21 is a schematic view of the alternative punch housing and punch holder, in a detached configuration;

FIG. 22 is a partial section view similar to FIG. 2, but additionally showing a mandrel assembly to support the piping during punching;

FIG. 23 is a section view of the clamp block of FIG. 22 along line FF;

FIG. 24 is a section view of the die of FIG. 22;

FIG. 25 is a schematic section view of an alternative mandrel assembly to support the piping during punching;

FIG. 26 is a section view of the die of FIG. 25 along line GG; and

FIG. 27 is a section view of the arbor of FIG. 25 along line HH.

### DETAILED DESCRIPTION OF PREFERRED EMBODIMENTS

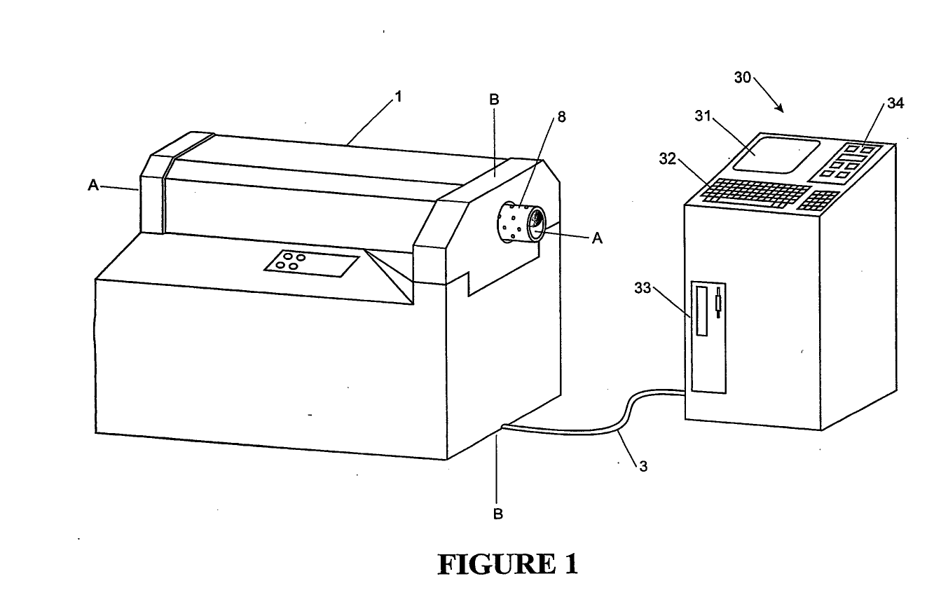

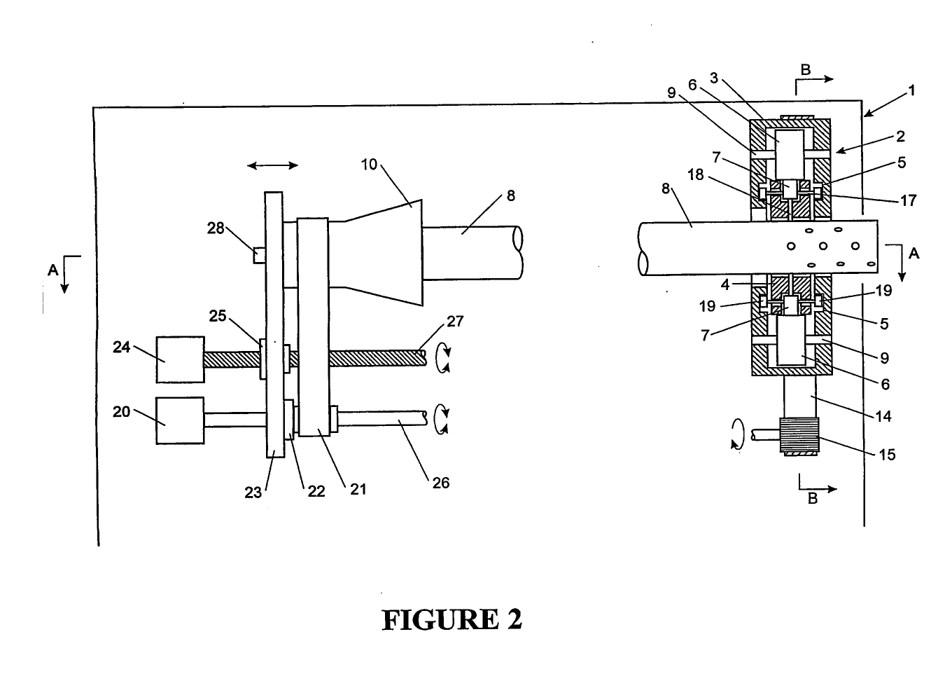

Referring to FIGS. 1 and 2, the preferred form perforating apparatus 1 includes a perforating mechanism 2 (on line BB) which is driven by a hydraulic motor 15, a chuck 10 which grips and moves a length of piping 8 rotationally and longitudinally (along line AA) through the perforating mechanism 2, and electric servo or stepping motors 20 and 24 which drive the chuck 10. The motors 15, 20 and 24 are controlled to co-ordinate the perforations performed by the perforating mechanism 2 as it rotates with rotational and longitudinal movement of the piping 8 by the chuck 10 to allow predetermined perforation patterns to be carried out on the piping 8.

The perforating mechanism 2 and chuck 10 may alternatively be driven by different combinations of pneumatic, hydraulic or electric motors, for example the motors 15, 20 and 24 may all be electric servomotors. The mechanism 2 and chuck 10 are preferably belt driven 14 and 21 respectively, but other drive arrangements are possible. For example, the chuck 10 may be driven by a suitable gearbox arrangement from the mechanisms 2 motor 15.

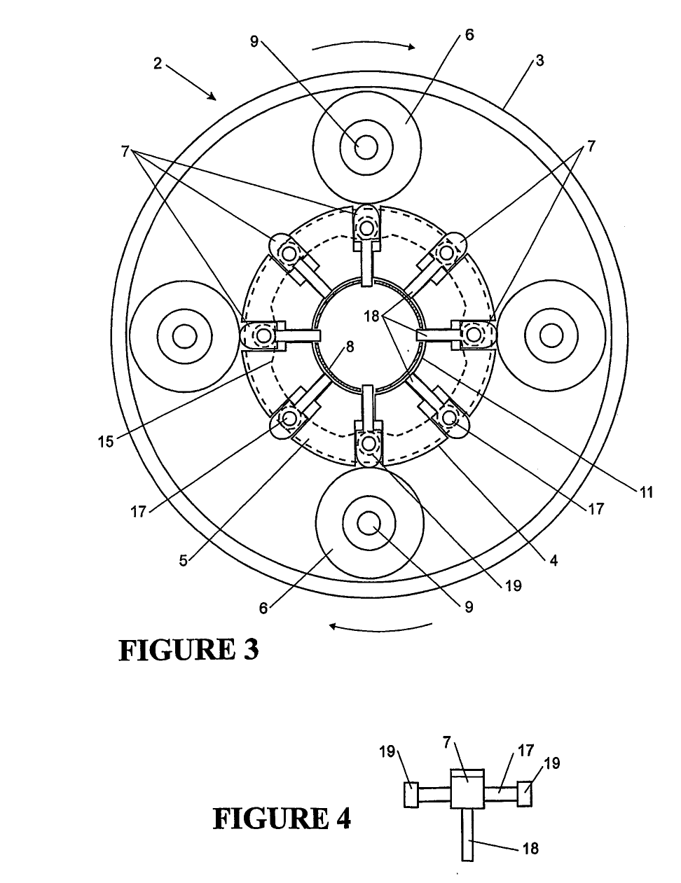

Referring to FIG. 3 the perforating mechanism 2 comprises: a punch housing hub 4, eight punches 7, an annular housing 3 which includes punch retracting channels 5 and four punch engaging rollers 6.

The annular housing 3 rotates about the hub 4 as shown by the direction arrows. Four rollers 6 are secured to the annular housing 3 by axles 9 such that they are arranged at 90 intervals around the housing 3. The rollers 6 rotate with the housing 3 such that they roll around the outside of the hub 4. The rollers 6 engage or depress the punches 7 upon contact such that the engaged punches 7 perforate a corresponding section of piping 8. The punches 7 are arranged at 45 intervals around the hub 4, which ensures that four punches 7 are engaged simultaneously by their rollers 6.

Other arrangements of the rollers 6 and punches 7 are possible where the rollers 6 or punches 7 are separated by different angles, also different combinations of roller 6 and punch 7 numbers can be used. In an extreme example of the apparatus 2, a single roller 6 and punch 7 may be employed.

Referring additionally to FIG. 4, the punches 7 each include a pin 17 which protrudes out of the hub 4 to interact with the retracting channels 5. Small wheels or rollers 19 are located at the ends of the pin 17 which roll around inside the channels 5. The retracting channels 5 rotate with the housing 3 and interact with the pins 17 such that the punches 7 are retracted from the piping 8 after contact with the rollers 6. The channels 5 are substantially circular in shape, but include regions of reduced radius or dips 15 to allow the punches 7 in contact with the rollers 6 to be engaged into the piping 8. As the housing 3 rotates, the rollers 6 roll past the punches 7 and the section of the channels 5 in contact with the pins 17 increases radius such that the punches 7 are retracted from the piping 8.

Alternatively a punch retracting cam(s) or disk(s) with an external profile equivalent to the channels 5 may be secured to or formed integrally with the flanged housing 3.

The punches 7 are easily removable from the hub 4 so that they may be replaced with punches 7 of different perforation face 18 size and/or shape. Different punch 7 lengths may also be used to accommodate a range of piping 8 diameters. For piping 8 of substantially smaller diameter than the hub 4 internal cavity 11, a shroud (not shown) should be used to centre the piping 8. The shroud includes passages corresponding to the punches 7 travel to the piping 8.

Referring to FIG. 2, the chuck drive assembly comprises: the chuck 10, rotational and longitudinal drive motors 20 and 24 respectively, a carriage assembly 23, a pulley 22 mounted on a first shaft 26, a sleeve 25 mounted on a second shaft 27, a chuck axle 28 and a belt drive 21.

The chuck 10 is rotatably mounted on the chuck axle 28 which is secured to the carriage assembly 23. The sleeve 25 is secured to the carriage 23 such that as the second shaft 27 is rotated by the longitudinal drive motor 24, the sleeve 25 interacts with a thread or spiral grooves in the second shaft 27 such that it drives the carriage 23 and chuck 10 longitudinally. The pulley 22 is rotatably mounted to the carriage 23 and is longitudinally movable along the first shaft 26. As the first shaft 26 is rotated by the rotational drive motor 20, the pulley 22 drives the chuck 10 rotationally via the belt drive 21.

The apparatus 1 also includes a chuck 10 clamping and unclamping mechanism (not shown) which secures the piping 8 for perforation, and releases it upon completion.

Referring to FIGS. 2 and 3, the hydraulic motor 15 rotates the housing 3 of the perforating mechanism 2 at a uniform rate, preferably 60 revolutions per minute. The chuck 10 motors 20 and 24 are controlled to operate the chuck such that the piping 8 is moved relative to the punch housing 4 to perform a pattern of perforations. The hydraulic motor 15 speed can be adjusted, for example it can be reduced for low density perforation patterns where the piping 8 movements between perforations by the mechanism 2 are relatively large.

As the housing 3 is rotated, the four rollers 6 roll around the outside of the hub 4 and each simultaneously contact the protruding head of a punch 7. The channels 5, which rotate with the housing 3 and rollers 6, present a dip 15 at this point to allow the punches 7 to be engaged by the rollers 6 to perforate the piping 8 at (notionally) 0, 90, 180 and 270. As the housing 3 rotates further, the rollers 6 lose contact with the punches 7 and the channels 5 present a non-dipped profile which forces the punches 7 out of the piping 8 such that their heads again protrude above the hub 4. At this point the chuck 10 may either: retain the piping 8 in its present position to allow further perforation by the next set of punches at (notionally) 45, 135, 225, and 315; push the piping to its next longitudinal position and allow perforation at 45, 135, 225 and 315; rotate the piping 8 to allow perforation at other angles separated by 90 at the same longitudinal position; push and rotate the piping 8 to allow perforations at a different longitudinal position at 0, 90, 180 and 270 or other angles separated by 90. This combination of actions allows a wide variety of perforation patterns to be introduced into the piping 8.

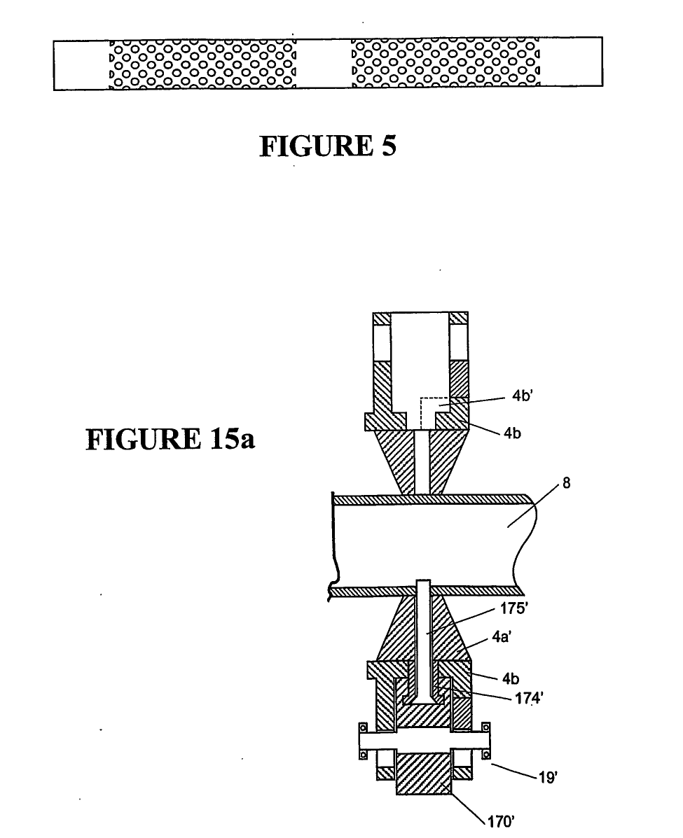

FIG. 5 shows a perforation pattern using eight perforations per longitudinal position which are displaced from the previous and next perforation set by 22½. To achieve this pattern the chuck 10 secures the piping 8 in a first longitudinal position while the perforating mechanism 2 rotates 90 and performs eight perforations at (notionally) 0, 45, 90, 135, 180, 225 and 315. The chuck 10 then pushes the piping 8 to the next longitudinal position and rotates it by 22½ before securing the piping 8 in this position for a further 90 rotation of the perforating mechanism 2. At the next longitudinal position the chuck 10 may either rotate the piping 8 by a further 22½ or rotate it back to its original rotational position.

Referring to FIG. 1, the preferred form control system comprises a computer program and a control panel 30 comprising: a computer 33, a screen 31, a keyboard 32, manual controls 34, and a cable connection 35 to the apparatus 1.

The manual controls 34 include start and emergency stop controls, chuck 10 clamp and unclamp controls for secuing or releasing the piping 8, and chuck 10 lateral movement controls. The controls 34 allow the operator to load a length of piping into the apparatus 1, prior to initialising perforation; and to remove the perforated piping 8.

The program loaded onto a computer 33 in the control panel 30 allows an operator to select from a wide variety of preset perforation patterns, customise a unique pattern or instruct the program to calculate a pattern automatically according to parameters such as the area of piping to be removed. The motors 15, 20 and 24 of the apparatus 2 are then controlled to perforate the piping 8 according to the selected, customised or automatically generated perforation patterns. Alternatively a simpler controller such as a PLC contained within the apparatus 1 could be used. This could, for example, be used in an apparatus 1 where only one or a limited number of preset perforation patterns are required.

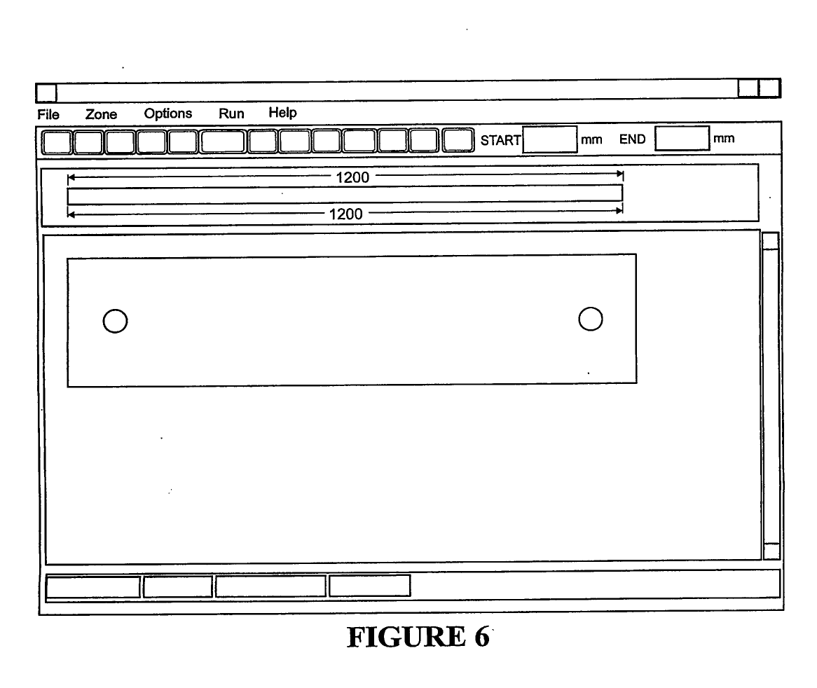

The program is preferably in the form of a menu driven program which allows the operator using the keyboard 32 and screen 31, to either select a perforation pattern from an available range contained in a database, customise a pattern or instruct the program to generate a pattern automatically. FIG. 6 shows a start up screen with, from the top, an options row each generating a popup menu screen (not shown) when selected, a quick options icon row, a piping overview diagram, a perforation pattern diagram, and a working parameters row. The piping overview diagram displays the piping 8 length and one or more zones of perforation or sections of the piping 8. The perforation pattern diagram displays a 90 or quarter section of piping 8 over a particular zone. Each perforation or hole image on the pattern diagram represents four perforations separated by 90 in the piping 8. A pattern for that zone can then either be customised, automatically generated, or copied from another zone on the same piping 8 or from a data base of perforation patterns. Additionally, a pattern drawn from the data base can then be customised. The parameters row can include: the current zone of the perforation pattern diagram; the number of holes in the piping 8 resulting from the current pattern; the area of piping 8 removed by the perforation pattern; the hole size; the piping wall thickness; and other desired working parameters.

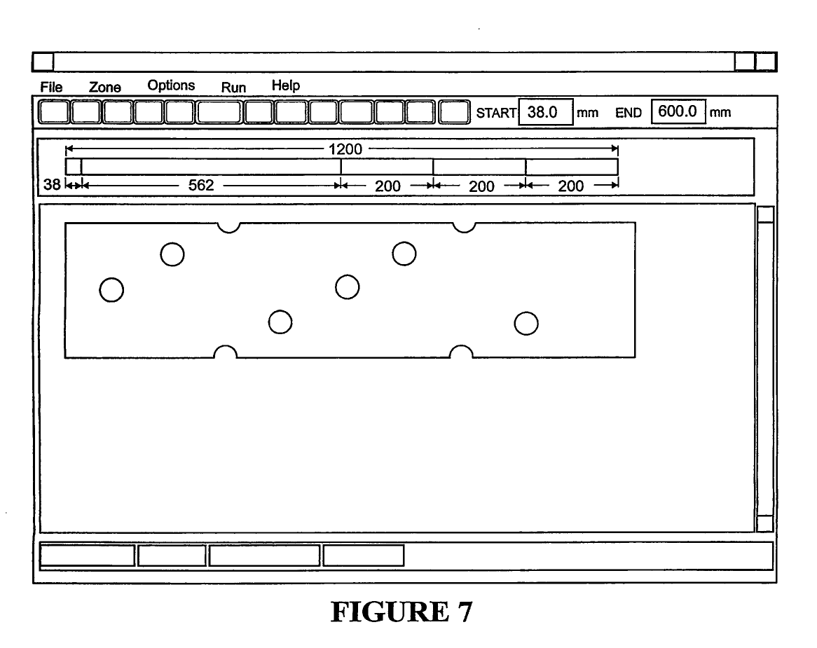

To enter a perforation pattern, the file option is chosen which then displays a popup menu with new or open perforation file options. The open option allows the selection of a perforation pattern from the data base. FIG. 7 shows a selection with a 1200 mm length pipe with two perforation zones at 38 to 600 mm and 800 to 1000 mm (as shown in the piping overview diagram). The perforation pattern diagram shows a spiral perforation pattern in the first zone. The number of zones and each zone's length and pattern can be adjusted using the zone option. When the perforation pattern for the piping is completed, the run option is selected such that the required apparatus 1 motor 15, 20 and 24 movements are calculated and carried out. Once set up, a perforation pattern can be rerun for any number of piping 8.

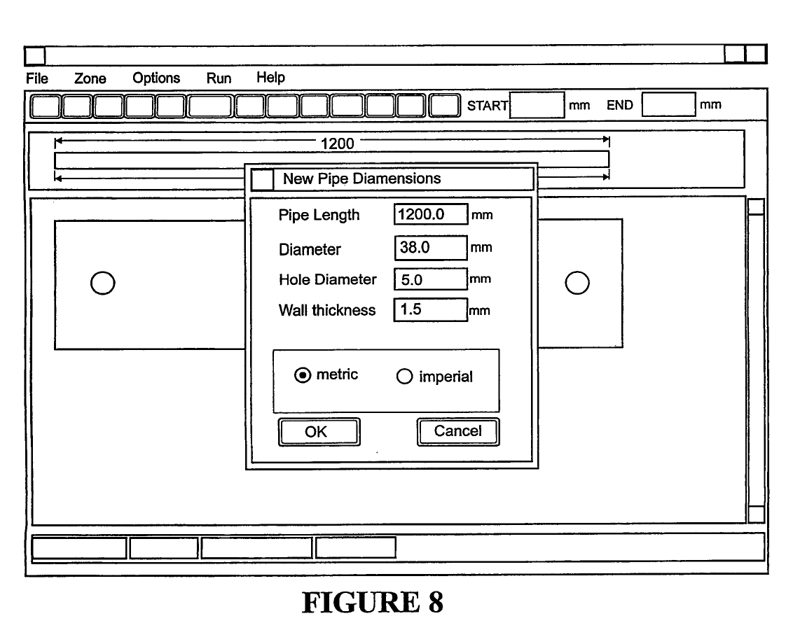

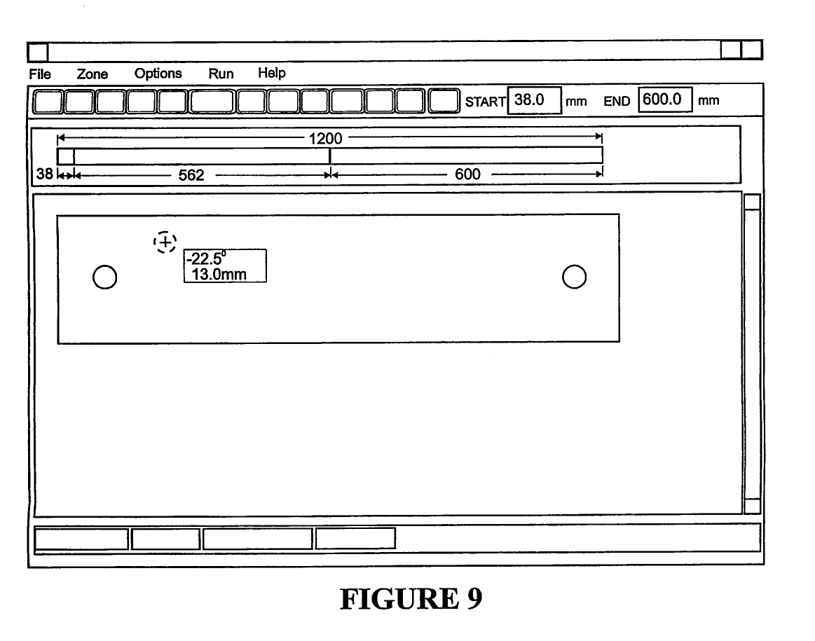

To set up a new or customised pattern, the new menu option from the file option of the startup screen in FIG. 6 is selected, which generates a popup new pipe dimensions screen as shown in FIG. 8. The operator then enters the new pipe length, diameter, hole diameter and/or wall thickness dimensions. The required number and size of zones is entered using the zone option. The current working zone can be selected either with the zone option or with an equivalent icon. A new perforation pattern can then be created for each zone by selecting the perforation icon (rightmost) with a mouse cursor then guiding the resultant hole image on the perforation diagram as shown in FIG. 9. The hole image shows the hole in dashed outline as well as its position relative to a permanent first hole at a notional position of 0 and 0 mm. The hole image can be placed at 0, −22.5, +22.5 and +45 and at any longitudinal distance from the first permanent hole in the zone. Each hole image represents four holes spaced at 90 or a set of perforations around the piping corresponding to the simultaneous engaging of four punches 7 by the rollers 6 of the perforating mechanism 2 as shown in FIG. 3. By repeating this hole image or set placement procedure a customised perforation pattern can be built up which when completed can be copied to another zone, stored in the data base and/or run and performed on piping 8 loaded in the apparatus 1. A pattern retrieved from the data base can also be modified using the customising procedure outlined above.

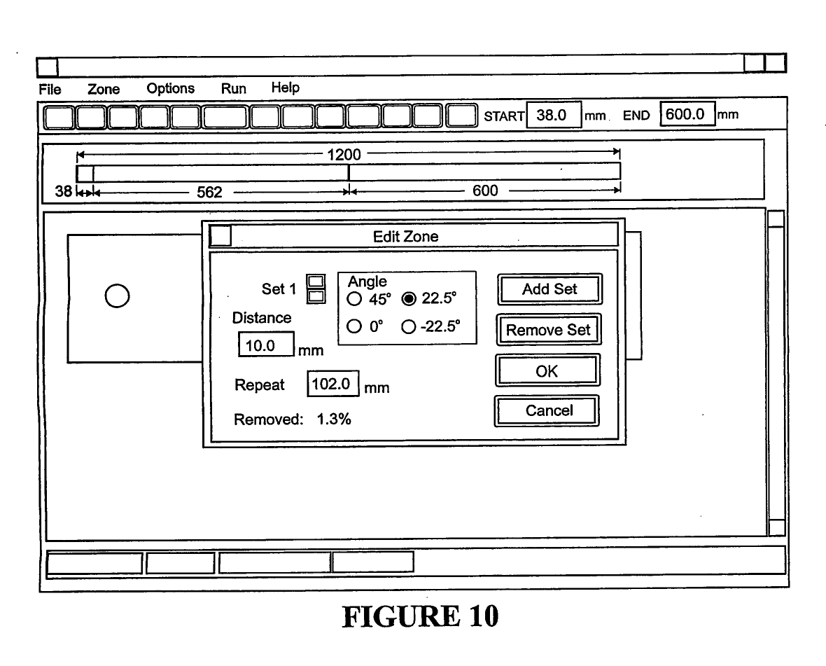

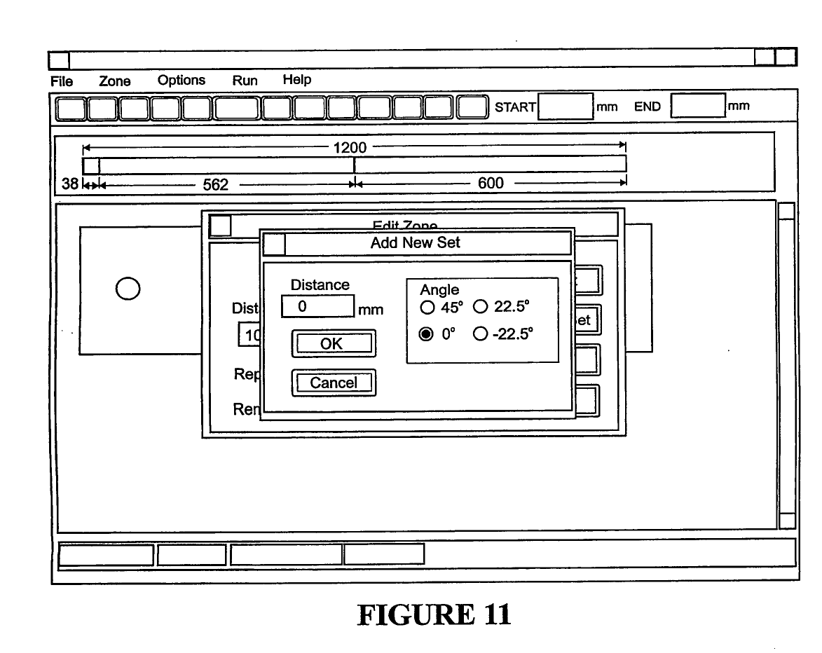

Alternatively the zone edit menu options can be used to add or remove sets of perforations or holes as shown in FIG. 10. If one or more sets have been previously added, these can be removed by selecting the angle and distance with respect to the 25 permanent first set and the remove set icon. To add a new set, the add set icon is selected which generates the popup screen shown in FIG. 11. The new set's angle (0°, −22.5°, +22.5° or +45°) and distance with respect to the permanent first set can then be entered. The edited zone pattern is then displayed on the perforation pattern diagram.

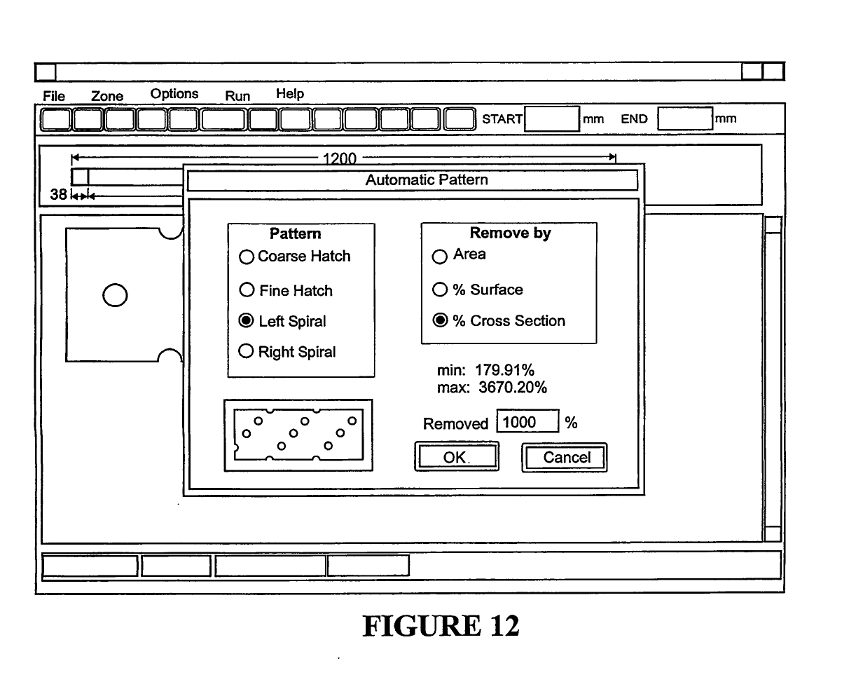

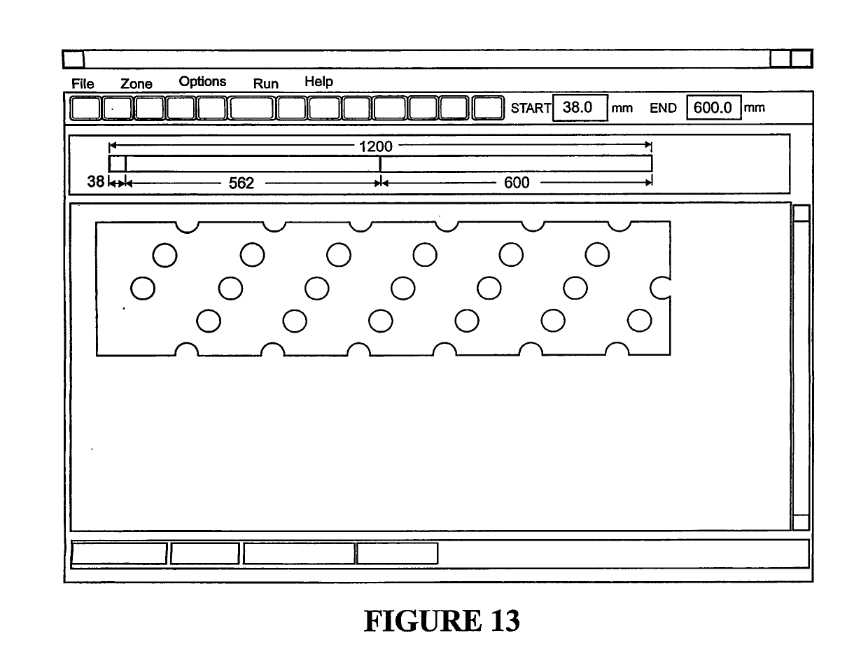

The program can be used to automatically calculate a pattern for a zone using the zone automatic menu options. Course or fine hatch, left or right spiral patterns can then be selected as shown in FIG. 12. The amount of piping to be removed by the perforation pattern can be selected by actual surface area, percentage of piping surface area, or by percentage of the cross sectional area of the piping. Maximum and minimum possible values are generated by the program according to parameters including the zone size, perforation size, number of punches and pattern type. FIG. 13 shows an automatically generated left spiral pattern with 1000% of the piping's cross sectional area removed, for a zone length of 562 mm, a piping diameter of 38 mm, a hole diameter of 5 mm and a piping wall thickness of 1.5 mm. Other pattern types or parameters could also be used to automatically generate a pattern. Once completed, the automatically generated perforation pattern can be copied to another zone or to the database.

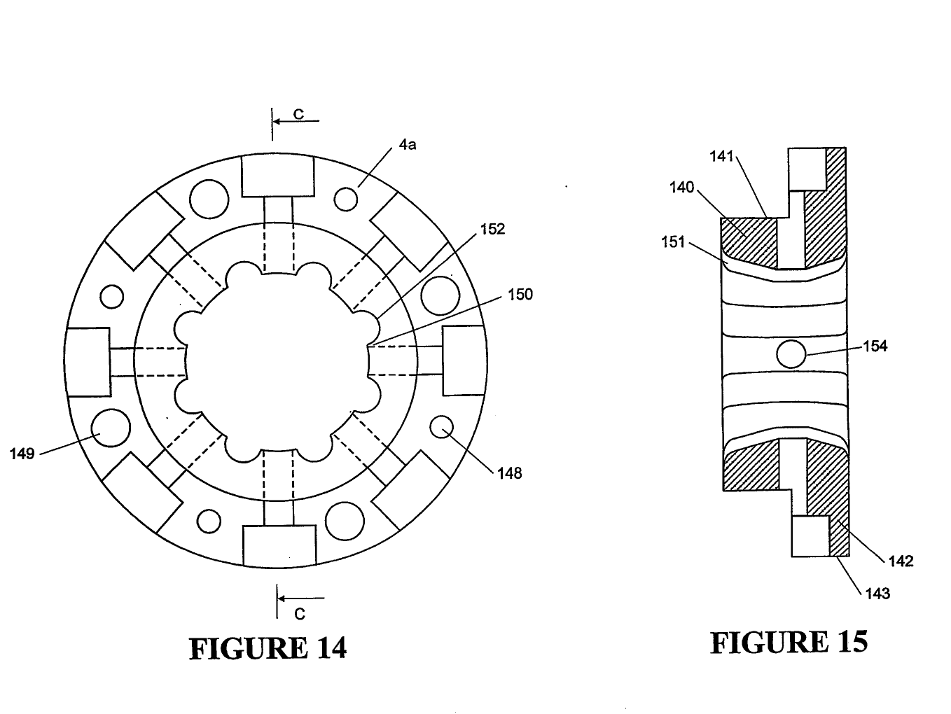

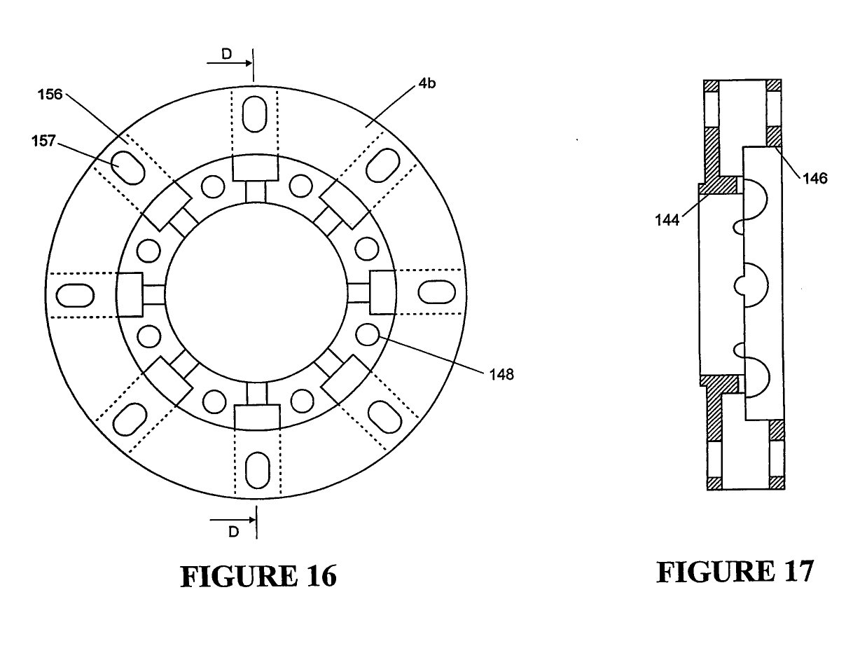

FIGS. 14 to 19 show an alternative embodiment punch housing and annular housing which may be used in the perforating apparatus of FIG. 1, in which like reference numbers are used to indicate like parts.

The main difference between the alternative punch housing and the punch housing described above is that the alternative punch housing includes two separable housing body parts, one of which may act as a tool holder for the punches. Further, the alternative embodiment punch housing utilises punch holders, and the punch holders and separable housing body parts enable ready replacement of punches.

With reference to FIGS. 14 to 17, the alternative punch housing 4 has an inner housing part 4a and an outer housing part 4b. The inner and outer housing parts may be removably attached together. In this regard, the inner housing part 4a has a hub portion 140 having an outer diameter indicated by reference numeral 141 and a flange portion 142 having an outer diameter indicated by reference numeral 143. The outer housing part 4b defines a central stepped aperture with corresponding diameters indicated by reference numerals 144 and 146 respectively. The inner 4a and outer 4b housing parts include apertures 148 such that the housing parts may be removably attached together using fastening means such as bolts through four of the apertures. There are four further apertures 149 having enlarged diameters in the inner housing part 4a.

In use, the outer housing part 4b is attached to a shaft using fastening means such as bolts through four alternate apertures. The inner housing part 4a may then be inserted into the outer housing part 4b such that the bolt heads are positioned within the enlarged diameter apertures 149 of the inner housing part. The inner housing part 4a and outer housing part 4b may then be fastened together using fastening means through the four smaller apertures.

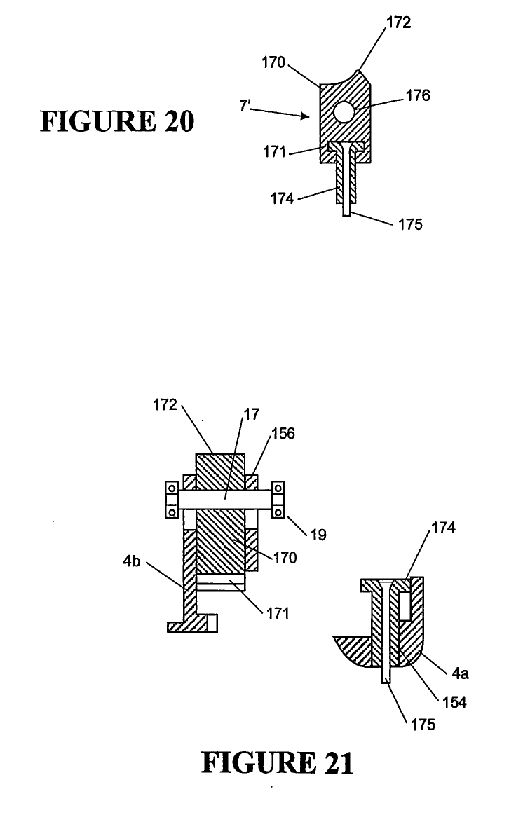

One advantage of this embodiment is that the inner housing part 4a may be easily removed and replaced with another having a central aperture 150 of a different diameter for use in perforating different diameter piping 8. The inner housing part 4a may be removed from the outer housing part 4b by simply removing four bolts. The inner housing part 4a also acts as a tool holder for part of the punch holder as will be described with reference to FIGS. 20 and 21, enabling ready replacement of punches.

The inner 4a and outer 4b housing parts define eight radial apertures 154,156 oriented at 45° angles within which eight punch holders are movably mounted. The respective apertures 154,156 are aligned when the inner 4a and outer 4b punch housing parts are bolted together.

As can be seen from FIG. 14, the central aperture 150 of the inner punch housing part 4a defines a plurality of arcuate grooves 152 to minimise friction on the piping 8 therein. Further, as can be seen from the section view of FIG. 15, the central aperture 15 is double-flared with radiused outer edges 151 to enhance movement of the piping 8 therethrough.

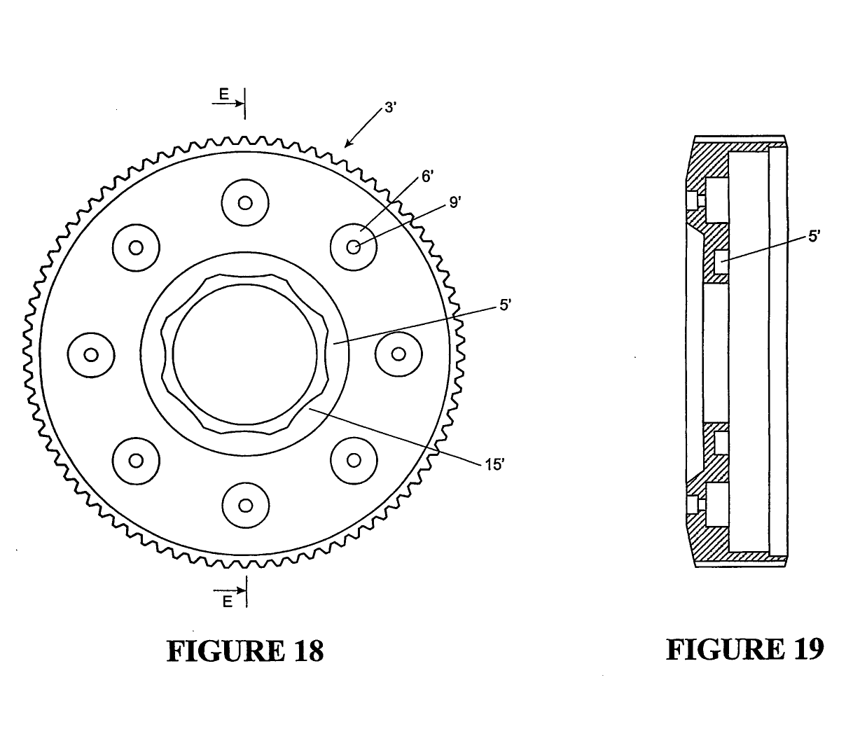

The annular housing 3′ shown in FIG. 18 is similar to the housing shown in FIG. 3, but differs in that the housing 3′ has eight rollers 6′ secured to the annular housing 3′ by axles 9′ such that they are arranged at 45° intervals around the housing 3′. Further, the periphery of the annular housing 3 is toothed, such that rotation of the annular housing may be effected using a chain, a toothed belt or gears. The preferred drive means for the annular housing is an electric servo motor.

Rather than using unitary punches, the alternative embodiment utilises punch holders 7′, as shown in FIG. 20. Each punch holder 7′ includes a main body portion 170 defining a T-slot 171 at one end thereof The opposite end of the main body portion 170 is formed with an offset protrusion 172. The offset protrusion 172 increases the dwell time between punches as the rollers 6′ run over the punch, compared to that which would be provided if the main body portion 170 had a flat or gently curved surface.

Each punch holder 7′ further includes an insert 174 with a tubular body and an enlarged head, the head being sized such that it may be removably mounted in the T-slot of the main body portion 170. The aperture in the centre of the insert 174 has a chamfered portion at the enlarged head end in order to hold a punch 175 therein.

Inserts 174 having different inner diameters may be used, to allow the use of different diameter punches. For example, in the machine it may be desirable to use four punches of one diameter alternating with four punches of a larger diameter, so that each alternate hole punched in the tube is larger than it's neighbouring hole.

In order to insert a punch 175 in the punch holder 7′, the insert 174 is removed from the T-slot 171 of the main body portion, and a punch 175 is placed therein. The insert 174 may then be reconnected to the main body portion 170 by sliding the enlarged head of the insert into the T-slot.

FIG. 21 shows how the punch housing and punch holder components are configured to enable easy changing of the punches. In the assembled configuration of the punch housing 4′, the punch holder 7′ extends through the apertures 154,156. The main body portion 170 of each punch holder 7′ is slidably mounted within a respective aperture 156 of the outer punch housing body part 4b. A pin 17 extends through an aperture 176 in the main punch holder body portion 170 and through elongate grooves 157 in the outer punch housing body part 4b. Small wheels or rollers 19 are located at the ends of each pin 17 and interact with the channel 5′ of the annular housing 3′ in the same manner as described above with reference to FIGS. 2 and 3.

As will be apparent from FIG. 21, when the inner punch housing part 4a is detached from the outer punch housing part 4b, the punch holder inserts 174 are detached from the T-slots 171 of the main punch holder body portion 170 and are held within the apertures 154 of the inner punch housing part. Accordingly, the inner punch housing part 4a acts as a tool holder for the punch inserts 174, and it will be appreciated that all of the punches will be exposed for easy replacement when the inner punch housing part 4a has been detached from the outer punch housing part 4b.

An advantage of using the punch holder is that standard off-the-shelf punches may be utilised in the perforating machine, resulting in lower costs.

It will be understood that the punching operation using the alternative annular housing 3′, punch housing 4′ and punch holders 7′ is substantially the same as that described with reference to FIGS. 1 to 4 and will not be described further here. However, it will be appreciated that due to the annular housing 3′ having eight rollers, all eight punches are engaged concurrently, resulting in twice as many punches being made as described with reference to FIGS. 1 to 4.

FIG. 15 shows a modified inner punch housing part 4a′ for use with the outer punch housing part 4b. Unless otherwise described below, the features of the inner punch housing part 4a′ can be taken to be the same as inner punch housing part 4a. Rather than using fasteners to connect inner punch housing part 4a′ to outer punch housing part 4b, the punches maintain the housing parts in the desired configuration as shown in FIG. 15. A separate clamping ring 4b′ (shown in hidden detail) is provided, which is fastened to a shaft and to the outer punch housing part 4b, to mount the outer punch housing part relative to the machine. The inner housing part 4a′ includes a plurality of radial apertures, with the outer housing part 4b including a corresponding arrangement of radial apertures. A punch 175′ is held within a punch insert 174′, which is held within a punch holder main body portion 170′ which is slidably received in the outer housing part 4b. The punch 175′ extends through the aperture in the inner housing part 4a′ to maintain the housing parts in the desired configuration. A pin again extends through elongate slots in the main body portion 170′, and small bearings or rollers 19′ are mounted on the ends of the pin to engage with the punch retracting mechanism.

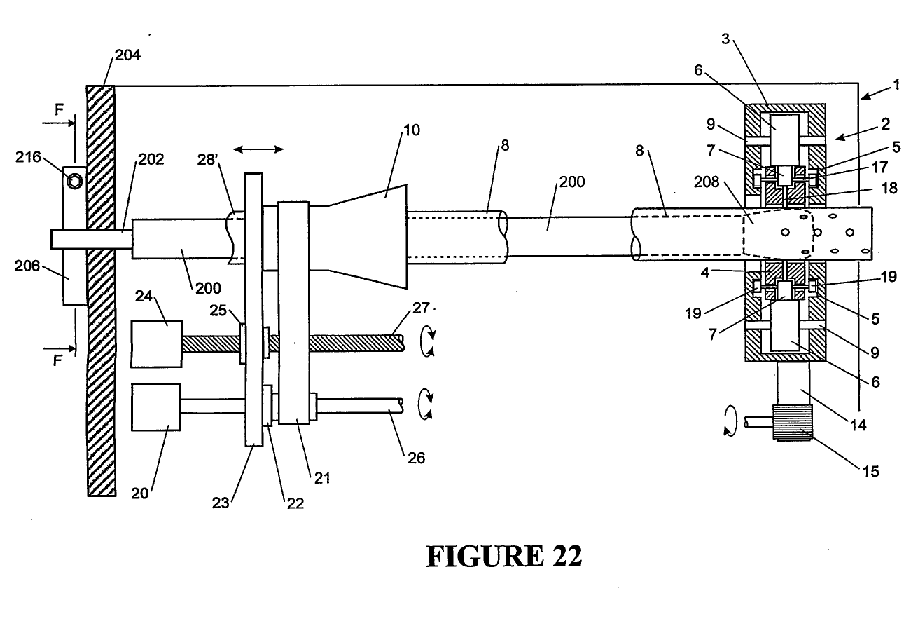

FIG. 22 shows a partial sectional view of the apparatus similar to FIG. 2, which differs in that it shows a mandrel assembly having an arbor and die for supporting the pipe during punching. The arbor 200 has a portion of reduced diameter 202 at one end thereof which extends through an arbor support 204 of the machine and is clamped in a clamping block 206. The arbor 200 extends through the chuck 10 and the piping 8 when the piping is gripped by the chuck 10. The chuck axle 28′ is hollow, such that the arbor can extend therethrough.

As shown in FIG. 24, attached to the other end of the arbor 200 is a die 208 which supports the piping during punching. The die 208 is attached to the arbor 200 by a fastening means such as a bolt 210.

The die includes a plurality of radial apertures 212. The number and orientation of the apertures 212 corresponds to the number and orientation of the radial apertures 154, 156 in the punch housing and, accordingly, the number and orientation of the punches 7, 175.

In use, when the piping 8 is being punched, the punches extend through the piping 8 and into the apertures 212 in the die 208. The outer surface of the die 208 supports the inside of the piping during punching.

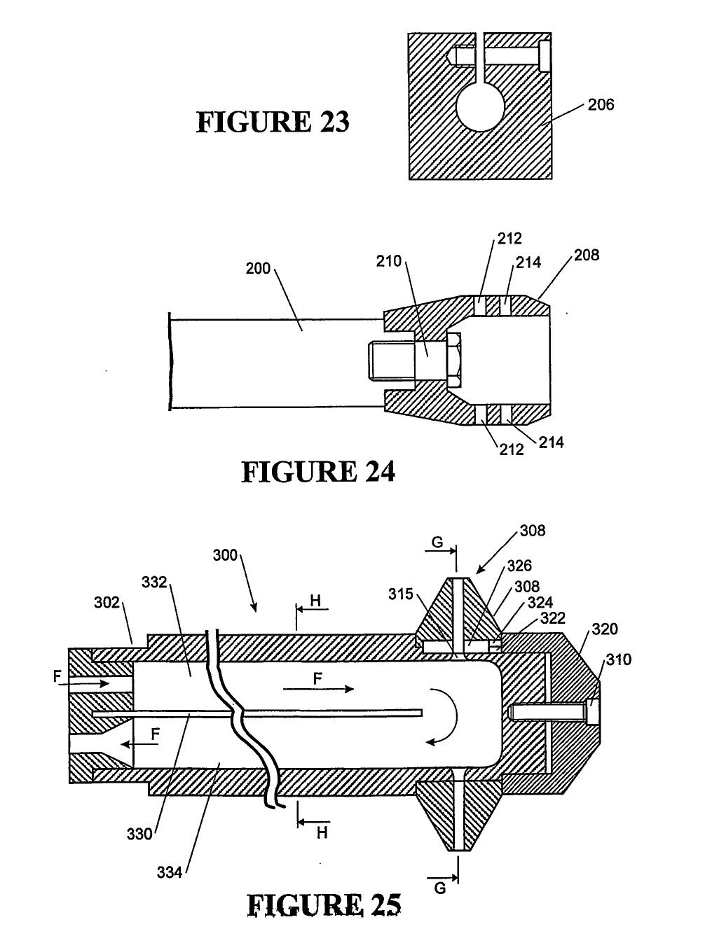

As can be seen from FIGS. 22 and 23, the clamping block 206 may be tightened using a fastener such as a set screw 216 which extends between two halves of the clamping block. When the set screw 216 in the clamping block 206 is tightened, the reduced diameter portion 202 of the arbor 200 is rigidly held therein, which fixes the position of the die 208 relative to the punch housing. When the set screw 216 in the clamping block 216 is loosened, the arbor 200 may be longitudinally and rotationally moved relative to the clamping block. The advantage of this configuration is that the clamping block may be loosened, and the die 208 readily positioned such that the apertures 212 in the die are aligned with the punches. The set screw 216 is then tightened to maintain the die 208 in the desired position, and the piping 8 may be placed over the die 208 and arbor 200 and gripped by the chuck 10 ready for punching.

The die 208 includes a second set of apertures 214 corresponding to and longitudinally spaced from the first set of apertures 212. When the first set of apertures 212 wear out, the clamping block 206 may be loosened and the die 208 moved longitudinally such that the second set of apertures 214 is aligned with the punches. This extends the useful life of the die 208.

FIG. 25 shows a sectional view of an alternative mandrel assembly for supporting the pipe during punching. The mandrel assembly has an arbor 300 and a die 308. The arbor 300 again has a portion of reduced diameter 302 at one end thereof which may extend through an arbor support of the machine and be clamped in a clamping block in the manner described above The arbor 300 will again extend through the chuck 10 and the piping 8 when the piping is gripped by the chuck 10. The chuck axle 28′ is hollow, such that the arbor can extend therethrough.

Attached to the other end of the arbor 300 is a die 308 which supports the piping during punching. The die 308 is held in position on the arbor 300 by a clamp collar 320, which is fastened to the arbor 300. A fastening means such as a fixing cap screw 310 extends through an aperture in the clamp collar 320 and into an aperture in an end wall of the arbor, and holds the die clamp collar 320 axially against the die 308 to maintain the die 308 in position on the arbor 300.

A keyway 322 is provided in the arbor 300, with a corresponding keyway 324 in the die 308. A key 326 maintains the alignment between the arbor 300 and the die 308. The key 326 is maintained between the arbor and the die by the die clamp collar 320.

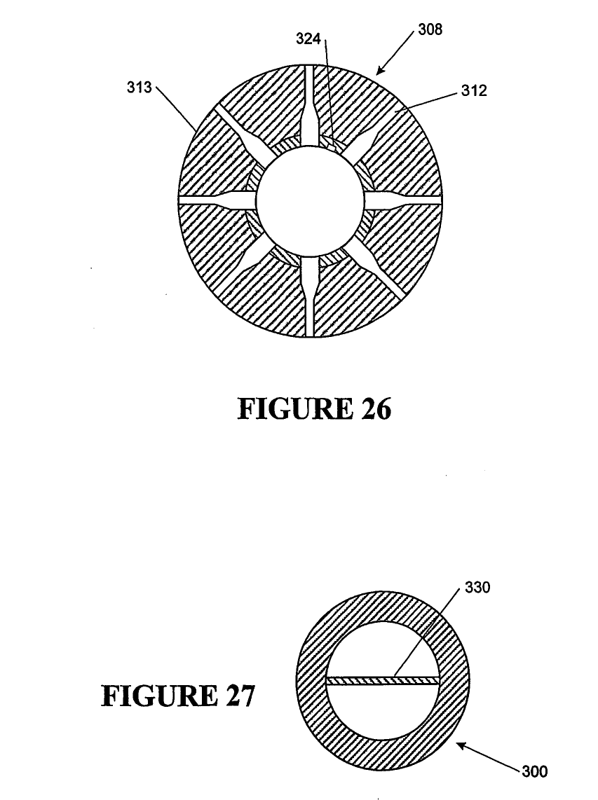

As can be seen from FIG. 26, the die 308 includes a plurality of radial apertures 312. The perimeter of the die has semi-flat surfaces 313 between the radial apertures 312, to minimise friction on the inside of the tubing being punched. The number and orientation of the apertures 312 preferably corresponds to the number and orientation of the radial apertures 154, 156 in the punch housing and, accordingly, the number and orientation of the punches 7, 175.

In use, when the piping 8 is being punched, the punches extend through the piping 8 and into the apertures 312 in the die 308. Corresponding apertures 315 extend through the arbor. The outer surface of the die 308 supports the inside of the piping during punching.

Although not shown in the Figures, the die 308 may include a second set of radial apertures corresponding to and longitudinally spaced from the first set of apertures 312 as described for the die 208 above.

As shown in FIG. 25, the arbor 300 has a central aperture, one open end and one closed end, and includes an elongate dividing wall 330. This divides the central aperture into a flow input path 332 and a flow output path 334.

A source of high pressure fluid is in fluid connection with the flow input path 332. In use, the fluid enters the input path 332, flows around the end of the dividing wall 330, and flows out of the arbor via the flow output path 334. The fluid is preferably a coolant fluid.

The mandrel assembly may be used with other perforating apparatus.

The advantages of circulating a coolant fluid through the arbor and die is twofold. Due to the length of the arbor and the close clearance of the punches and die, the changes in ambient temperature as the machine warms up during operation may cause some expansion of the arbor, meaning that the die could become misaligned with the punch head. Pumping a temperature controlled coolant fluid through the arbor addresses this. Further, if the fluid is pumped through the arbor and die at high pressure, it acts as a medium to carry punch slugs (waste material) away from the die area as these will fall through apertures 312, 315 during punching. This, and the fact that the end of the arbor/die is closed off so the slugs are removed through the arbor (rather than possibly building up outside or around the die) reduces the chances of the punching area or punched tube becoming jammed by slugs. This is particularly advantageous if an automatic pipe loader is to be used, and even more so if one end of the pipe is perforated then the pipe is withdrawn and turned around so the other end can be perforated.

The preferred embodiment perforation apparatus described above enable perforation patterns to be easily selected and rapidly applied to piping or tubing. The punch retracting mechanism does not require the use of punch retracting springs, which are prone to jamming.

The foregoing describes the invention including a preferred form thereof Alterations and modifications as will be obvious to those skilled in the art are intended to be incorporated within the scope hereof

For example, the preferred embodiment has one or more rollers axially secured to the annular housing. It will be appreciated that a roller could instead be provided on the end of the punch(es), the roller(s) engaging against one or more fixed members or cam shafts mounted on the annular housing. Further, it is not essential that rollers are used. Rather, the punch(es) or annular housing could include one or more camming surfaces such as a cam shaft or fixed member for example, with the other of the punch(es) or annular housing including one more engagement surfaces, such that the camming surfaces and engagement surfaces interact during rotation of the annular housing to depress the punches. The camming surfaces and engagement surfaces could be manufactured from a self-lubricating polymer plastic for example, to enhance movement therebetween.

1. A perforation apparatus suitable for perforating tubing or piping including:
a punch housing including an aperture through which piping is longitudinally and rotationally moveable and one or more punches arranged radially around the aperture and operable to perforate piping passing through the punch housing;
a driven annular housing including an aperture corresponding to the punch housing aperture, one or more rollers axially secured to the annular housing, the annular housing being arranged to rotate adjacent the punch housing such that roller(s) roll(s) around the punch housing to operate the punch(es) upon contact, and a punch retracting mechanism arranged to retract the punch(es) after each operation;
a mechanism to move the piping relative to the punch housing; and
a mechanism to drive the annular housing and the piping moving mechanism.

2. A perforation apparatus suitable for perforating tubing or piping including:
a punch housing including an aperture through which piping is longitudinally and rotationally moveable and one or more punches arranged radially around the aperture and operable to perforate piping passing through the punch housing;
a driven annular housing including an aperture corresponding to the punch housing aperture and a punch retracting mechanism, the annular housing being arranged to rotate adjacent the punch housing;
either the punch(es) or the annular housing including one or more camming surfaces and the other of the punch(es) and the annular housing including one or more engagement surfaces, the annular housing being arranged to rotate adjacent the punch housing such that the camming surface(s) engage(s) the engagement surface(s) to operate the punch(es) upon contact, the punch retracting mechanism arranged to retract the punch(es) after each operation;
a mechanism to move the piping relative to the punch housing; and
a mechanism to drive the annular housing and the piping moving mechanism

3. A perforation apparatus as claimed in claim 2, wherein the punch(es) include(s) a roller, and the annular housing includes one or more cam shafts.

4. A perforation apparatus as claimed in claim 2, wherein one or more rollers are axially secured to the annular housing and arranged to engage a surface on the punch(es) during rotation of the annular housing.

5. A perforation apparatus as claimed in claim 2, wherein the punch retracting mechanism includes a channel or recess around the annular housing which co-operates with a projection from the punch(es) wherein the profile of the channel or recess is such that the punch(es) is/are retracted after each operation; or the punch retracting mechanism includes a punch retracting disk with an external profile which co-operates with a projection from the punch(es) wherein the external profile of the punch retracting disk is such that the punch(es) is/are retracted after each operation and the punch retracting mechanism is formed integrally with or secured to the driven annular housing.

6. (canceled)

7. A perforation apparatus as claimed in claim 5, wherein roller(s) is/are axially secured to the annular housing, and the channel or recess around the annular housing or the external profile of the punch retracting disk is substantially circular in shape, but includes one or more regions of reduced radius or one or more dips radially aligned with the roller(s).

8. A perforation apparatus as claimed in claim 5, wherein the projection includes at least one wheel or small roller which engages the punch retracting mechanism.

9. A perforation apparatus as claimed in claim 2, wherein the punch housing includes one or more radial apertures for receipt of the punch(es).

10. A perforation apparatus as claimed in claim 2, wherein the punch housing includes an inner punch housing part having an aperture through which piping is longitudinally and rotatably moveable and an outer punch housing part, the inner and outer punch housing parts being separable.

11. A perforation apparatus as claimed in claim 10, wherein the inner punch housing part is interchangeable with a further inner punch housing part having a different internal diameter for receipt of different diameter piping.

12. A perforation apparatus as claimed in claim 10, wherein the inner punch housing part includes a hub and a flange, which are receivable in respective parts of a central stepped aperture of the outer punch housing part.

13. A perforation apparatus as claimed in claim 10 including one or more radial apertures, wherein the radial aperture(s) extend(s) through the inner and outer punch housing parts when the housing parts are engaged together.

14. A perforation apparatus as claimed in claim 10, wherein the inner housing part and/or outer housing part include one or more apertures for receipt of one or more fasteners to fasten the housing parts together.

15. A perforation apparatus as claimed in claim 10 wherein the inner housing part also serves as a tool holder and is separable from the outer housing part with the punches maintained in the inner housing part.

16. A perforation apparatus as claimed in claim 10, wherein the punch(es) include(s) a projection which co-operates with the punch retracting mechanism, the outer punch housing part including a corresponding number of elongate radial slots through which a respective projection extends.

17. A perforation apparatus as claimed in claim 2, wherein the aperture of the punch housing through which piping is longitudinally and rotatably moveable includes a plurality of arcuate grooves to reduce friction on piping therein.

18. A perforation apparatus as claimed in claim 2, wherein the aperture of the punch housing through which piping is longitudinally and rotatably moveable is flared to guide movement of piping therethrough.

19. A perforation apparatus as claimed in claim 2, wherein the periphery of the driven annular housing includes a plurality of teeth, such that rotation of the annular housing may be effected using a chain, toothed belt, or gears.

20. A perforation apparatus as claimed in claim 2, wherein the punch(es) is/are receivable in a respective punch holder(s), which is/are receivable in the punch housing.

21. A perforation apparatus as claimed in claim 20, wherein the punch holder(s) include(s) a main body portion including a substantially T-shaped slot at one end thereof for receipt of a punch or insert.

22. A perforation apparatus as claimed in claim 21, wherein the punch holder(s) include(s) a removable insert having a tubular body and an enlarged head, the head being receivable within the substantially T-shaped slot of the punch holder(s), with the punch receivable in the insert.

23. A perforation apparatus as claimed in claim 22 and including inner and outer punch housing parts, arranged such that as the inner punch housing part is detached from the outer punch housing part, the punch holder insert(s) is/are detached from the substantially T-shaped slot(s) of the punch holder main body portion(s) and held within the inner housing part.

24. A perforation apparatus as claimed in claim 20, wherein the punch holder(s) include(s) a main body portion, the main body portion including a transverse aperture for receipt of a pin to form the a projection to engage with the punch retracting mechanism.

25. A perforation apparatus as claimed in claim 20, wherein the punch holder(s) include(s) a main body portion, and an end of the main body portion includes an offset protrusion against which the roller(s) engage(s) in use.

26. A perforation apparatus as claimed in claim 2, wherein the mechanism to drive the annular housing includes a motor.

27. A perforation apparatus as claimed in claim 26, wherein the motor is an electric servo motor.

28. A perforation apparatus as claimed in claim 2, wherein the mechanism to move the piping relative to the punch housing includes a chuck arranged to selectively grip the piping.

29. A perforation apparatus as claimed in claim 28, wherein the mechanism to drive the piping moving mechanism is configured to longitudinally and rotationally move the chuck.

30. A perforation apparatus as claimed in claim 29, wherein the mechanism to drive the piping moving mechanism includes independently actuable rotational and longitudinal drive motors.

31. A perforation apparatus as claimed in claim 30, wherein the rotational and longitudinal drive motors are electric servo motors.

32. A perforation apparatus as claimed in claim 2, including a mandrel assembly to support the piping during punching.

33. A perforation apparatus as claimed in claim 32, wherein the mandrel assembly includes an arbor and a die extending therefrom and configured to support the piping during punching.

34. A perforation apparatus as claimed in claim 33, wherein the die includes one or more radial apertures corresponding to the position of the punch(es).

35. A perforation apparatus as claimed in claim 34 including a plurality of apertures, wherein the perimeter of the die includes semi-flat surfaces between the apertures to minimise friction on the inside of the piping.

36. A perforation apparatus as claimed in claim 34, wherein the arbor is held within a clamping block, and is selectively releasable therefrom so that the die is axially and rotatably moveable relative to the punch(es).

37. A perforation apparatus as claimed in claim 34, wherein the die includes a second set of apertures axially spaced from the first set of apertures.

38. A perforation apparatus as claimed in claim 33, wherein the interior of the arbor is separated by a dividing wall into a fluid inlet path and a fluid outlet path, with the fluid inlet path in fluid communication with a source of high pressure fluid to remove waste punching material from inside the die.

39. A perforation apparatus as claimed in claim 38, wherein the fluid is a coolant fluid.

40. A perforation apparatus as claimed in claim 33, including a die clamping collar to attach the die to the arbor.

41. A perforation apparatus as claimed in claim 40, including a keyway in an outer surface of the arbor and a corresponding keyway in an inner surface of the die, and a key located in the keyways to maintain alignment between the die and the arbor, the key being maintained in the keyways by the die clamping collar.

42. A perforation apparatus as claimed in claim 2, including a control system configured to control and coordinate the longitudinal and rotational movement of the piping through the punch housing with the operation of the punch(es), to cause the apparatus to perforate a predetermined, selected part or parts of the piping, with a predetermined, selected arrangement or pattern of perforations.

43. A perforation apparatus as claimed in claim 2, wherein the punch housing includes eight punches at about 45° angular spacing.

44. A perforation apparatus as claimed in claim 2, wherein the annular housing includes four rollers at about 90° angular spacing.

45. A perforation apparatus as claimed in claim 2, wherein the annular housing includes eight rollers at about 45° angular spacing.

46. A perforation apparatus suitable for perforating tubing or piping including:
a punch housing including an aperture through which the piping is longitudinally and rotationally movable and one or more punches arranged radially around the aperture and operable to perforate piping passing through the punch housing,
a mechanism to rotate and move the piping through the punch housing, and
a control system configured to control and coordinate the longitudinal and rotational movement of the piping through the punch housing with the operation of the punch(es), to cause the apparatus to perforate a predetermined, selected part or parts of the piping, with a predetermined, selected arrangement or pattern of perforations.

47. A perforation apparatus as claimed in claim 46, wherein the punch housing includes a plurality of punches arranged radially around the aperture.

48. A perforation apparatus as claimed in claim 46, wherein the control system enables an operator to select from a preset perforation pattern, customise a unique pattern or instruct the system to calculate a pattern automatically.

49. A perforation apparatus as claimed in claim 48, wherein the control system enables a user to input a piping length, piping diameter, hole diameter, wall thickness dimensions, and the number and size of the perforation zone(s).

50. A perforation apparatus as claimed in claim 48, wherein the control system is operable to calculate a pattern automatically based on the actual surface area, percentage of piping surface area, or percentage of cross-sectional area of the piping.

51. A perforation apparatus as claimed in claim 46, wherein the control system includes a computer, a display and an input device to enable a user to input or select a desired arrangement or pattern of perforations.

52. A perforation apparatus as claimed in claim 51, wherein the computer is loaded with a computer program which allows an operator to select a preset perforation pattern, customise a pattern, or instruct the program to calculate a perforation pattern according to parameters.

53. A perforation apparatus as claimed in claim 46, wherein the control system enables an operator to select from a preset perforation pattern, and includes a programmable logic controller (PLC).

54. A perforation apparatus as claimed in claim 46, wherein the control system is configured to control a punch actuation motor, a longitudinal piping movement motor and a rotational piping movement motor.

55. A mandrel assembly for supporting tubing or piping as it is being punched in a perforation apparatus including:
an arbor having an internal aperture divided by a dividing wall into a fluid inlet path and a fluid outlet path;
a die for supporting the tubing or piping and attached at or toward an end of the arbor, the die having a one or more radial apertures for receipt of one or more punches;
the fluid inlet path being directly or indirectly connectable to a source of high pressure fluid, and the fluid inlet path and fluid outlet path defining a flow path around which the high pressure fluid can flow to remove waste punch slugs from the vicinity of the die.

56. A mandrel assembly as claimed in claim 55, wherein the fluid inlet channel is in fluid communication with a source of high pressure coolant fluid.

57. A mandrel assembly as claimed in claim 55, including a die clamping collar to attach the die to the arbor.

58. A mandrel assembly as claimed in claim 57, including a keyway in an outer surface of the arbor and a corresponding keyway in an inner surface of the die, and a key located in the keyways to maintain alignment between the die and the arbor, the key being maintained in the keyways by the die clamping collar.
